(19) United States
(12) Patent Application Publication
(10) Pub. No.: US 2021/0182838 A1
(43) Pub. Date: Jun. 17, 2021

(54) SYSTEM FOR TRACKING RESOURCES IN A DISTRIBUTED ENVIRONMENT

(71) Applicant: Bank of America Corporation, Charlotte, NC (US)

(72) Inventors: Prashant Khare, Mumbai (IN); Nimish Deshpande, Mumbai (IN)

(73) Assignee: Bank of America Corporation, Charlotte, NC (US)

(21) Appl. No.: 16/717,170

(22) Filed: Dec. 17, 2019

(51) Int. Cl. G06Q 20/36; H04L 9/06; H04L 9/32; G06Q 20/06

(52) U.S. Cl. CPC G06Q 20/3672; H04L 9/0637; G06Q 20/0658; G06Q 20/3674; H04L 9/3236

(57) ABSTRACT

Systems, computer program products, and methods are described herein for identifying an entity associated with a genesis resource transfer in a block chain distributed environment by implementing a layered block architecture. The present invention is configured to receive an indication that a first entity has executed a first resource transfer with a second entity; generate a first block associated with the first resource transfer for a blockchain distributed ledger, wherein the first block comprises a cryptographic hash for the first resource transfer, and a cryptographic hash for the first entity as a resource transfer entity; display the first block associated with the first resource transfer for validation to validating nodes; electronically receive an indication that the first block has been validated based on logic and rules associated with the blockchain distributed ledger; determine that a consensus requirement has been met; and update the blockchain distributed ledger with the first block.

### FIELD OF THE INVENTION

The present invention embraces a system for identifying an entity associated with a genesis resource transfer in a block chain distributed environment by implementing a layered block architecture.

### BACKGROUND

The blockchain is a chain of blocks which contain specific information (database), but in a secure and genuine way that is grouped together in a network (peer-to-peer). In other words, blockchain is a combination of computers linked to each other instead of a central server, meaning that the whole network is decentralized. However, the information contained in each block is limited to cryptographic hashes associated with the resource transfer executed by the entity.

There is a need for a layered architecture for entity identification in a distributed electronic server system.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for identifying an entity associated with a genesis resource transfer in a block chain distributed environment by implementing a layered block architecture is presented. The system comprising: at least one non-transitory storage device; and at least one processing device coupled to the at least one non-transitory storage device, wherein the at least one processing device is configured to: electronically receive an indication that a first entity has executed a first resource transfer with a second entity, wherein the first resource transfer comprises a transfer of one or more resources associated with the first entity; generate a first block associated with the first resource transfer for a blockchain distributed ledger, wherein the first block comprises a cryptographic hash for the first resource transfer, and a cryptographic hash for the first entity as a resource transfer entity; transmit control signals configured to cause one or more computing devices associated with one or more validating nodes to display the first block associated with the first resource transfer for validation; electronically receive, from the one or more computing devices associated with the one or more validating nodes, an indication that the first block has been validated based on one or more logic and rules associated with the blockchain distributed ledger; determine that a consensus requirement has been met based on at least receiving the indication that the first block has been validated; and update the blockchain distributed ledger with the first block based on at least determining that the consensus requirement has been met.

In some embodiments, the at least one processing device is further configured to: electronically receive an indication that the second entity has executed a second resource transfer with a third entity, wherein the second transfer comprises the transfer of the one or more resources received by the second entity from the first entity via the first resource transfer and one or more resources associated with the second entity that were not received by the second entity from the first entity via the first resource transfer; and generate a second block associated with the second resource transfer for blockchain distributed ledger, wherein the second block comprises a cryptographic hash for the second resource transfer, the cryptographic hash for the first resource transfer, a cryptographic hash for the second entity as the resource transfer entity, and the cryptographic hash for the first entity as an originating entity.

In some embodiments, the at least one processing device is further configured to: transmit control signals configured to cause the one or more computing devices associated with the one or more validating nodes to display the second block associated with the second resource transfer for validation; electronically receive, from the one or more computing devices associated with the one or more validating nodes, an indication that the second block has been validated based on the one or more logic and rules associated with the blockchain distributed ledger; determine that the consensus requirement has been met based on at least receiving the indication that the second block has been validated; and update the blockchain distributed ledger with the second block based on at least determining that the consensus requirement has been met, wherein updating further comprises cryptographically linking the second block to the first block.

In some embodiments, the at least one processing device is further configured to: generate a third block associated with the second resource transfer for the blockchain distributed ledger, wherein the third block comprises a cryptographic hash for the second resource transfer indicating the transfer of the one or more resources received by the second entity from the first entity via the first resource transfer, the cryptographic hash for the second resource transfer, a cryptographic hash for the second entity as the resource transfer entity, and the cryptographic hash for the first entity as the originating entity; and generate a fourth block associated with the second resource transfer for the blockchain distributed ledger, wherein the fourth block comprises a cryptographic hash for the second resource transfer indicating the transfer of the one or more resources associated with the second entity that were not received by the second entity from the first entity via the first resource transfer, the cryptographic hash for the second resource transfer, the cryptographic hash for the second entity as the resource transfer entity, and a cryptographic hash for the second entity as the originating entity.

In some embodiments, the at least one processing device is further configured to: transmit control signals configured to cause the one or more computing devices associated with the one or more validating nodes to display the third block associated with the second resource transfer and the fourth block associated with the second resource transfer for validation; electronically receive, from the one or more computing devices associated with the one or more validating nodes, an indication that the third block and the fourth block has been validated based on the one or more logic and rules associated with the blockchain distributed ledger; determine that the consensus requirement has been met based on at least receiving the indication that the third block and the fourth block has been validated; and update the blockchain distributed ledger with the third block and the fourth block based on at least determining that the consensus requirement has been met, wherein updating further comprises cryptographically linking the third block to the second block and cryptographically linking the fourth block to the second block.

In some embodiments, the at least one processing device is further configured to: electronically receive an indication that the first entity wishes to execute the first resource transfer with the second entity; and determine that the first entity is an existing member of a consortium of entities, wherein determining further comprises: electronically receiving information associated with the first entity; comparing the information received from the first entity with information in a consortium database to determine a match; and determine that the first entity is an existing member of the consortium of entities based on at least determining the match.

In some embodiments, the at least one processing device is further configured to: electronically receive authentication credentials from a computing device associated with the first entity based on at least determining that the first entity is an existing member of the consortium of entities; verify the first entity based on at least receiving the authentication credentials from the computing device associated with the first entity; and authorize the first entity to execute the first resource transfer with the second entity based on at least verifying the first entity.

In yet another embodiment, computer implemented method for identifying an entity associated with a genesis resource transfer in a block chain distributed environment by implementing a layered block architecture, the method comprising: electronically receiving an indication that a first entity has executed a first resource transfer with a second entity, wherein the first resource transfer comprises a transfer of one or more resources associated with the first entity; generating a first block associated with the first resource transfer for a blockchain distributed ledger, wherein the first block comprises a cryptographic hash for the first resource transfer, and a cryptographic hash for the first entity as a resource transfer entity; transmitting control signals configured to cause one or more computing devices associated with one or more validating nodes to display the first block associated with the first resource transfer for validation; electronically receiving, from the one or more computing devices associated with the one or more validating nodes, an indication that the first block has been validated based on one or more logic and rules associated with the blockchain distributed ledger; determining that a consensus requirement has been met based on at least receiving the indication that the first block has been validated; and updating the blockchain distributed ledger with the first block based on at least determining that the consensus requirement has been met.

In yet another aspect, a computer program product for identifying an entity associated with a genesis resource transfer in a block chain distributed environment by implementing a layered block architecture is presented. The computer program product comprising a non-transitory computer-readable medium comprising code causing a first apparatus to: electronically receive an indication that a first entity has executed a first resource transfer with a second entity, wherein the first resource transfer comprises a transfer of one or more resources associated with the first entity; generate a first block associated with the first resource transfer for a blockchain distributed ledger, wherein the first block comprises a cryptographic hash for the first resource transfer, and a cryptographic hash for the first entity as a resource transfer entity; transmit control signals configured to cause one or more computing devices associated with one or more validating nodes to display the first block associated with the first resource transfer for validation; electronically receive, from the one or more computing devices associated with the one or more validating nodes, an indication that the first block has been validated based on one or more logic and rules associated with the blockchain distributed ledger; determine that a consensus requirement has been met based on at least receiving the indication that the first block has been validated; and update the blockchain distributed ledger with the first block based on at least determining that the consensus requirement has been met.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for identifying an entity associated with a genesis resource transfer in a block chain distributed environment by implementing a layered block architecture, in accordance with an embodiment of the invention;

FIG. 2 illustrates a distributed ledger broadcasting and linking within a distributed network environment, in accordance with an embodiment of the invention;

FIG. 3 illustrates a process flow for a system for identifying an entity associated with a genesis resource transfer in a block chain distributed environment by implementing a layered block architecture, in accordance with an embodiment of the invention;

FIG. 4 illustrates a layered block for entity identification in a distributed electronic server system, in accordance with an embodiment of the invention; and

FIG. 5 illustrates a layered block architecture for entity identification in a distributed electronic server system, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like.

As used herein, a “resource transfer” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. In the context of an entity such as a financial institution, a resource transfer may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that invokes or is detectable by the financial institution. In some embodiments, the user may authorize a resource transfer using at least a payment instrument (credit cards, debit cards, checks, digital wallets, currency, loyalty points), and/or payment credentials (account numbers, payment instrument identifiers). A resource transfer may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. In this regard, resource transfers or transactions may refer to the user initiating a purchase for a product, service, or the like from a merchant. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, a “blockchain” is a form of distributed ledger technology which employs a chain of blocks to secure and validate distributed consensus. A blockchain is distributed across and managed by peer-to-peer networks. Since it is a distributed ledger, it can exist without a centralized authority or server managing it, and its data quality can be maintained by database replication and computational trust. However, the structure of the blockchain makes it distinct from other kinds of distributed ledgers. Data on a blockchain is grouped together and organized in blocks. The blocks are then linked to one another and secured using cryptography. A blockchain provides numerous advantages over traditional databases. A large number of computing devices with access to a blockchain may reach a consensus regarding the validity of a transaction contained on the transaction ledger. Thus, a “valid” transaction is one that can be validated based on a set of rules that are defined by the particular system implementing the blockchain. Its append-only structure only allows data to be added to the database: altering or deleting previously entered data on earlier blocks is impossible. Blockchain technology is therefore well-suited for recording events, managing records, processing transactions, tracing resources, and voting. For purposes of the invention, the term “blockchain” and “distributed ledger” may be used interchangeably.

As used herein, “authentication credentials” may be any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

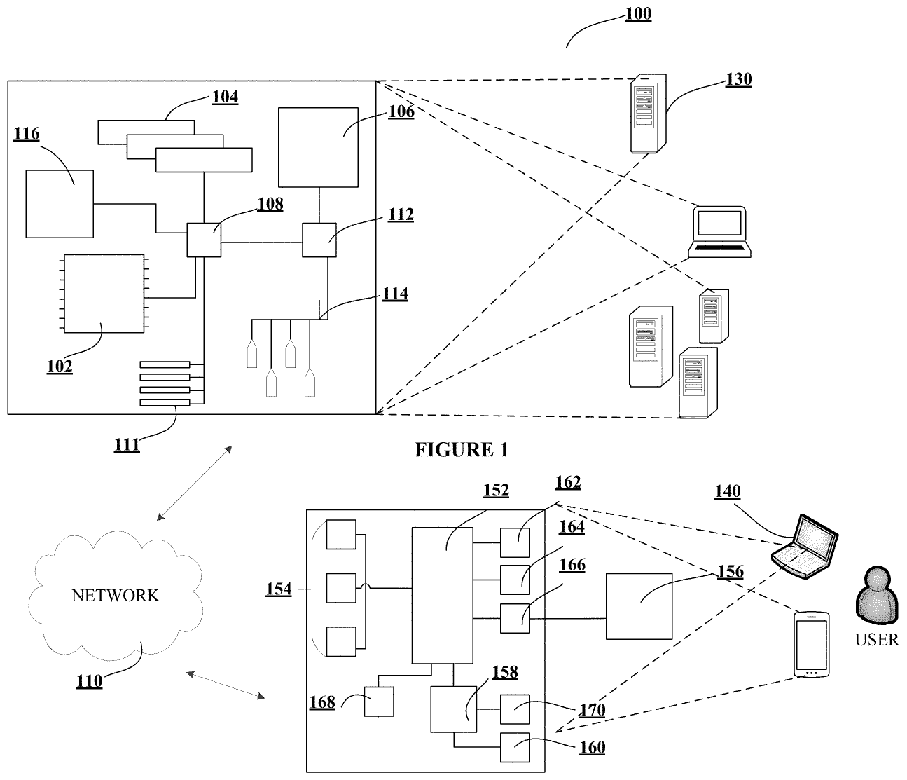

FIG. 1 presents an exemplary block diagram of the system environment for identifying an entity associated with a genesis resource transfer in a block chain distributed environment by implementing a layered block architecture 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute resource transfers using one or more applications stored thereon. The one or more applications may be configured to communicate with the system 130, execute a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application, and allows memory reuse for better utilization of the memory resources when the data sizes are large.

The high-speed interface 1408 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation—and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

Embodiments of the present invention contemplates the use of a decentralized blockchain configuration or architecture to facilitate a resource transfer using smart contracts distributed on a blockchain distributed network. Such a decentralized blockchain configuration ensures accurate mapping of resource transfer to entities. Accordingly, a blockchain configuration may be used to maintain an accurate ledger of resource transfer records and to provide validation of resource transfer.

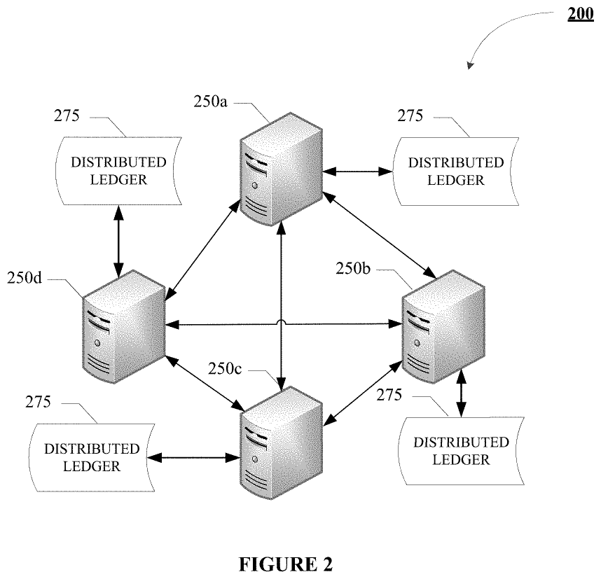

FIG. 2 illustrates a distributed ledger broadcasting and linking within a distributed network environment 200, in accordance with an embodiment of the invention. As described above and referring to FIG. 2, a distributed ledger 275 is maintained across several computing devices 250a, 250b, 250c, and 250d. Each computing device may have a complete or partial copy of the entire ledger. Resource transfers are initiated at a computing device and communicated to various other computing devices within the network. Any of these computing devices can validate a resource transfer, add the resource transfer to its copy of the distributed ledger 275, and/or broadcast the resource transfer, its validation (in the form of a block) and/or other data to other computing devices. These resource transfers on the distributed ledger 275 are then grouped together and organized in blocks. These blocks are then linked to one another, time-stamped, and secured using cryptography.

As described herein, a blockchain is a list of digital records (blocks), where each record stores information associated with resource transfers executed by an entity. In this regard, each block in the blockchain may include a cryptographic hash of the resource transfer that are linked to other blocks in the blockchain. In this way, the blockchain may be able to generate and maintain an auditable trail of resource transfers. Each block typically contains information associated with the resource transfer itself in the form of a cryptographic hash and in some instances, a cryptographic hash associated with the entity that has executed the resource transfer. However, there is need for a system to maintain an auditable track of the entity associated with the resource transfer in the genesis block—the first block in the blockchain protocol which is the basis on which additional blocks are added to the form a chain of blocks—throughout the blockchain lifetime of the resources transferred. Embodiments of the present invention contemplates generation of a blockchain for each entity that has previously executed a transfer of resources using the system described herein, and generate an auditable trail of not only the resources being transferred at each resource transfer, but also information associated with the entity associated with the resource transfer in the genesis block. In this regard, the system may be configured to generate a cryptographic hash of the originating entity and appending the cryptographic hash to each additional block that is associated with the resources transferred in the genesis block.

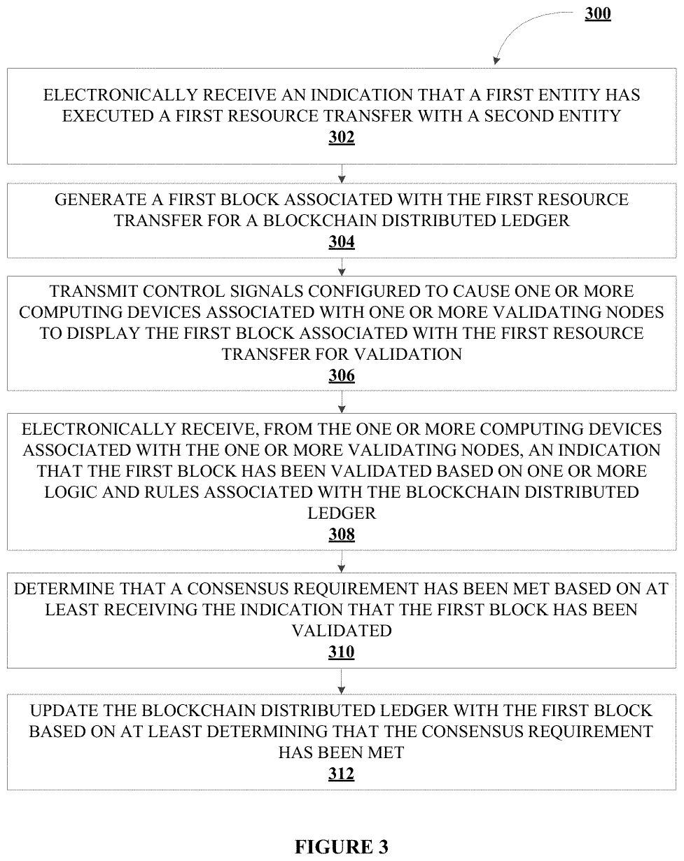

FIG. 3 illustrates a process flow for a system for identifying an entity associated with a genesis resource transfer in a block chain distributed environment by implementing a layered block architecture 300, in accordance with an embodiment of the invention. As shown in block 302, the process flow includes electronically receiving an indication that a first entity has executed a first resource transfer with a second entity. In one aspect, the first resource transfer comprises a transfer of one or more resources associated with the first entity. As described herein, the first entity may execute the first resource transfer using one or more computing devices associated with the first entity.

In some embodiments, the system may be configured to electronically receive an indication that the first entity wishes to execute the first resource transfer with the second entity. In response, the system may be configured to determine whether the first entity is an existing member of a consortium of entities. In this regard, the system may be configured to electronically receive information associated with the first entity. In one aspect, the information associated with the first entity may include, but is not limited to, any information or compilation of information relating to a business, procedures, techniques, methods, concepts, ideas, affairs, products, processes or services, including source code, information relating to distribution, marketing, merchandising, selling, research, development, manufacturing, purchasing, accounting, engineering, financing, costs, pricing and pricing strategies and methods, customers, suppliers, creditors, employees, contractors, agents, consultants, plans, billing, needs of customers and products and services used by customers, all lists of suppliers, distributors and customers and their addresses, prospects, sales calls, products, services, prices and the like, as well as any specifications, formulas, plans, drawings, accounts or sales records, sales brochures, catalogs, code books, manuals, trade secrets, knowledge, know-how, operating costs, sales margins, methods of operations, invoices or statements and the like.

In response to receiving the information associated with the first entity, the system may be configured to compare the information associated with the first entity with information in a consortium database to determine a match. In some embodiments, the consortium database may include information associated with one or more entities previously associated with the consortium of entities. In some embodiments, an entity may be associated with the consortium of entities if the entity has previously executed a transfer of resources with one or more other entities, either entities within the consortium of entities or entities that are outside the consortium of entities. In one aspect, each member of the consortium of entities may be associated with an existing blockchain with each resource transfer executed by the entity recorded in each block. In some embodiments, the system may be configured to determine that the first entity is an existing member of the consortium of entities based on at least determining the match.

In response to determining that the first entity is an existing member of the consortium of entities, the system may be configured to electronically receive authentication credentials from a computing device associated with the first entity based on at least determining that the first entity is an existing member of the consortium of entities. In response, the system may be configured to verify the first entity based on at least receiving the authentication credentials from the computing device associated with the first entity. In response to verifying the first entity, the system may be configured to authorize the first entity to execute the first resource transfer with the second entity.

In some embodiments, the system may be configured to determine whether the first entity is associated with any misappropriate activity based on at least the information in the blockchain associated with the first entity. In some aspect, the system may be configured to deny the first entity from executing the first resource transfer with the second entity if there is any indication of misappropriate activity. In response, the system may be configured to generate an alert indicating that the first entity is associated with misappropriate activity, and transmit the alert to the relevant authorities.

In some embodiments, the system may be configured to determine that the first entity is not an existing member of the consortium of entities based on at least comparing the information received from the first entity with information in a consortium database. In response, the system may be configured to initiate an entity onboarding process. In one aspect, the entity onboarding process is the process entities use to take on new clients, from the start of their journey to become a customer and beyond. For example, for an entity such as a financial institution to onboard a new customer, the financial institution may receive the necessary information from the first entity to facilitate any resource transfer the first entity wishes to execute.

Next, as shown in block 304, the process flow includes generating a first block associated with the first resource transfer for a blockchain distributed ledger. In one aspect, the first block includes a cryptographic hash for the first resource transfer, and a cryptographic hash for the first entity as a resource transfer entity. In some embodiments, the cryptographic hash may be generated using a cryptographic hash function which takes an input (or “message”) and returns a fixed-size string of bytes. As used herein, the string may be referred to as a cryptographic hash, hash value, message digest, digital footprint, digest, checksum, and/or the like. In this way, each cryptographic hash may act as a kind of “signature” for the information contained therein. Some commonly used cryptographic hash functions include MD5 and SHA-1, although many others also exist.

Next, as shown in block 306, the process flow includes transmitting control signals configured to cause one or more computing devices associated with one or more validating nodes to display the first block associated with the first resource transfer for validation. In some embodiments, the one or more validating nodes may be responsible for verifying resource transfers within associated with each block in the blockchain. By verifying the resource transfer, the validation nodes may determine that the resource transfer is “valid.”

Next, as shown in block 308, the process flow includes electronically receiving, from the one or more computing devices associated with the one or more validating nodes, an indication that the first block has been validated based on one or more logic and rules associated with the blockchain distributed ledger.

Next, as shown in block 310, the process flow includes determining that a consensus requirement has been met based on at least receiving the indication that the first block has been validated.

Next, as shown in bock 312, the process flow includes updating the blockchain distributed ledger with the first block based on at least determining that the consensus requirement has been met.

In some embodiments, the system may be configured to electronically receive an indication that the second entity has executed a second resource transfer with a third entity. In this regard, the second transfer comprises the transfer of the one or more resources received by the second entity from the first entity via the first resource transfer and one or more resources associated with the second entity that were not received by the second entity from the first entity via the first resource transfer. In response, the system may be configured to generate a second block associated with the second resource transfer for blockchain distributed ledger. In one aspect, the second block may include a cryptographic hash for the second resource transfer, the cryptographic hash for the first resource transfer, a cryptographic hash for the second entity as the resource transfer entity, and the cryptographic hash for the first entity as an originating entity.

In response to generating the second block, the system may be configured to transmit control signals configured to cause the one or more computing devices associated with the one or more validating nodes to display the second block associated with the second resource transfer for validation. In response, the system may be configured to electronically receive, from the one or more computing devices associated with the one or more validating nodes, an indication that the second block has been validated based on the one or more logic and rules associated with the blockchain distributed ledger. Once the second block has been validated, the system may be configured to update the blockchain distributed ledger with the second block based on at least determining that the consensus requirement has been met, wherein updating further comprises cryptographically linking the second block to the first block.

In some embodiments, the second resource transfer may be a combination of resources one or more resources received by the second entity from the first entity via the first resource transfer and one or more resources associated with the second entity that were not received by the second entity from the first entity via the first resource transfer. Accordingly, the system may be configured to generate a third block and a fourth block associated with the second resource transfer for the blockchain distributed ledger. In one aspect, the third block may include a cryptographic hash for the second resource transfer indicating the transfer of the one or more resources received by the second entity from the first entity via the first resource transfer, the cryptographic hash for the second resource transfer, a cryptographic hash for the second entity as the resource transfer entity, and the cryptographic hash for the first entity as the originating entity. In one aspect, the fourth block may include a cryptographic hash for the second resource transfer indicating the transfer of the one or more resources associated with the second entity that were not received by the second entity from the first entity via the first resource transfer, the cryptographic hash for the second resource transfer, the cryptographic hash for the second entity as the resource transfer entity, and a cryptographic hash for the second entity as the originating entity.

In response to generating the third and fourth block, the system may be configured to transmit control signals configured to cause the one or more computing devices associated with the one or more validating nodes to display the third block associated with the second resource transfer and the fourth block associated with the second resource transfer for validation. In response the system may be configured to electronically receive, from the one or more computing devices associated with the one or more validating nodes, an indication that the third block and the fourth block has been validated based on the one or more logic and rules associated with the blockchain distributed ledger. Once the third block and the fourth block have been validated, the system may be configured to update the blockchain distributed ledger with the third block and the fourth block based on at least determining that the consensus requirement has been met. In one aspect, updating the blockchain distributed ledger may include cryptographically linking the third block to the second block and cryptographically linking the fourth block to the second block.

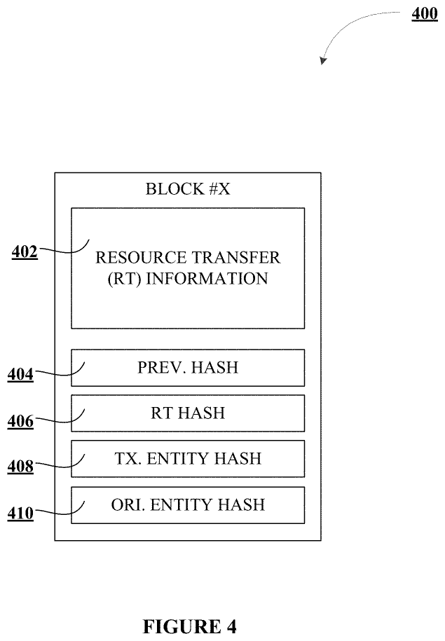

FIG. 4 illustrates a layered block for entity identification in a distributed electronic server system 400, in accordance with an embodiment of the invention. The layered block 400 includes at least block indicating resource transfer (RT) information 402, a cryptographic hash for a previous transaction hash 404, a cryptographic hash for the resource transfer (RT) 406, a cryptographic hash for the transaction entity 408, and a cryptographic hash for the original transacting entity 410. For example, if Jim received $200 from James, and transferred the $200 to Bob, the block associated with the transaction may include information indicating that Jim transferred $200 to Bob at 402, a cryptographic hash representing the transaction at 406, a cryptographic hash indicating that James transferred $200 to Jim 404, and a cryptographic hash for Jim, who is the transacting entity 408, and cryptographic hash for James, who was the originator of the $200 that Jim transferred to Bob.

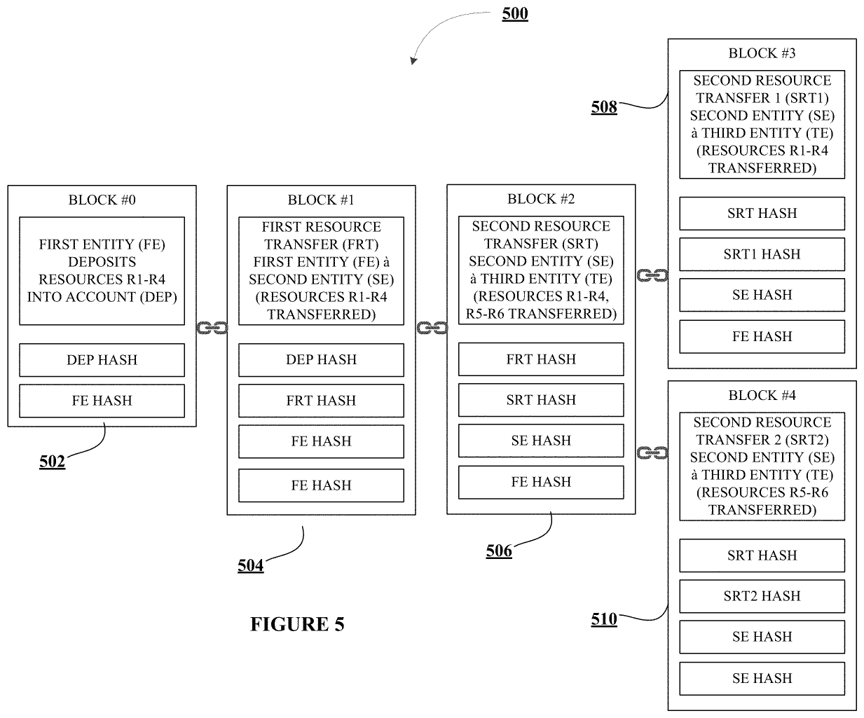

FIG. 5 illustrates a layered block architecture for entity identification in a distributed electronic server system 500, in accordance with an embodiment of the invention. The layered block architecture includes at least an originating block (block #0) 502, a first resource transfer block (block #1) 504, a second resource transfer block (block #2) 506, a first portion of the second resource transfer block (block #3) 508, and a second portion of the second resource transfer block (block #4) 510. Here, block #0 is the genesis block. For example, assume Jim opens a financial institution account and deposits $1000. Block #0 502 is generated containing information that indicates that Jim deposited $1000 in his financial institution account, a cryptographic hash for the $1000 deposit, and a cryptographic hash for Jim as the transacting entity. Next, assume Jim transfers $100 to Bob. Block #1 504 is generated containing information that indicates that Jim transferred $100 to Bob, a cryptographic hash for the $100 transfer, a cryptographic hash for Jim's initial $1000 deposit, which is the cryptographic hash for the immediately preceding transaction block, a cryptographic hash for Jim as the transacting entity, and a cryptographic hash for Jim as the originating entity (as the $100 came from the initial $1000 that deposited by Jim in his account). Next, assume Bob transfers $300 to James. Block #2 506 is generated containing information that indicates that Bob transferred $300 to James, a cryptographic hash for the $3000 transfer, a cryptographic hash for Jim's $100 transfer to Bob, which is the cryptographic hash for the immediately preceding transaction block, a cryptographic hash for Bob as the transacting entity, and a cryptographic hash for Jim as the originating entity. In some embodiments, instead of, or in addition to generating block #2, the system may be configured to generate block #3 508 and block #4 510. Block #3 508 is generated containing information that indicates that out of the $300 transferred by Bob to James, $100 of that originated from Jim, a cryptographic hash indicating that out of the $300 transferred by Bob to James, $100 of that originated from Jim, a cryptographic hash for Bob as the transacting entity, and a cryptographic hash for Jim as the originating entity. Block #4 510 is generated containing information that indicates that out of the $300 transferred by Bob to James, the other $200 was Bob's own funds, a cryptographic hash indicating that the other $200 was Bob's own funds, a cryptographic hash for Bob as the transacting entity, and a cryptographic hash for Bob as the originating entity.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for identifying an entity associated with a genesis resource transfer in a block chain distributed environment by implementing a layered block architecture, the system comprising:
at least one non-transitory storage device; and
at least one processing device coupled to the at least one non-transitory storage device, wherein the at least one processing device is configured to:
electronically receive an indication that a first entity has executed a first resource transfer with a second entity, wherein the first resource transfer comprises a transfer of one or more resources associated with the first entity;
generate a first block associated with the first resource transfer for a blockchain distributed ledger, wherein the first block comprises a cryptographic hash for the first resource transfer, and a cryptographic hash for the first entity as a resource transfer entity;
transmit control signals configured to cause one or more computing devices associated with one or more validating nodes to display the first block associated with the first resource transfer for validation;
electronically receive, from the one or more computing devices associated with the one or more validating nodes, an indication that the first block has been validated based on one or more logic and rules associated with the blockchain distributed ledger;
determine that a consensus requirement has been met based on at least receiving the indication that the first block has been validated; and
update the blockchain distributed ledger with the first block based on at least determining that the consensus requirement has been met.

2. The system of claim 1, wherein the at least one processing device is further configured to:
electronically receive an indication that the second entity has executed a second resource transfer with a third entity, wherein the second transfer comprises the transfer of the one or more resources received by the second entity from the first entity via the first resource transfer and one or more resources associated with the second entity that were not received by the second entity from the first entity via the first resource transfer; and
generate a second block associated with the second resource transfer for blockchain distributed ledger, wherein the second block comprises a cryptographic hash for the second resource transfer, the cryptographic hash for the first resource transfer, a cryptographic hash for the second entity as the resource transfer entity, and the cryptographic hash for the first entity as an originating entity.

3. The system of claim 2, wherein the at least one processing device is further configured to:
transmit control signals configured to cause the one or more computing devices associated with the one or more validating nodes to display the second block associated with the second resource transfer for validation;
electronically receive, from the one or more computing devices associated with the one or more validating nodes, an indication that the second block has been validated based on the one or more logic and rules associated with the blockchain distributed ledger;
determine that the consensus requirement has been met based on at least receiving the indication that the second block has been validated; and
update the blockchain distributed ledger with the second block based on at least determining that the consensus requirement has been met, wherein updating further comprises cryptographically linking the second block to the first block.

4. The system of claim 2, wherein the at least one processing device is further configured to:
generate a third block associated with the second resource transfer for the blockchain distributed ledger, wherein the third block comprises a cryptographic hash for the second resource transfer indicating the transfer of the one or more resources received by the second entity from the first entity via the first resource transfer, the cryptographic hash for the second resource transfer, a cryptographic hash for the second entity as the resource transfer entity, and the cryptographic hash for the first entity as the originating entity; and
generate a fourth block associated with the second resource transfer for the blockchain distributed ledger, wherein the fourth block comprises a cryptographic hash for the second resource transfer indicating the transfer of the one or more resources associated with the second entity that were not received by the second entity from the first entity via the first resource transfer, the cryptographic hash for the second resource transfer, the cryptographic hash for the second entity as the resource transfer entity, and a cryptographic hash for the second entity as the originating entity.

5. The system of claim 4, wherein the at least one processing device is further configured to:
transmit control signals configured to cause the one or more computing devices associated with the one or more validating nodes to display the third block associated with the second resource transfer and the fourth block associated with the second resource transfer for validation;
electronically receive, from the one or more computing devices associated with the one or more validating nodes, an indication that the third block and the fourth block has been validated based on the one or more logic and rules associated with the blockchain distributed ledger;
determine that the consensus requirement has been met based on at least receiving the indication that the third block and the fourth block has been validated; and
update the blockchain distributed ledger with the third block and the fourth block based on at least determining that the consensus requirement has been met, wherein updating further comprises cryptographically linking the third block to the second block and cryptographically linking the fourth block to the second block.

6. The system of claim 1, wherein the at least one processing device is further configured to:
electronically receive an indication that the first entity wishes to execute the first resource transfer with the second entity; and
determine that the first entity is an existing member of a consortium of entities, wherein determining further comprises:
electronically receiving information associated with the first entity;
comparing the information received from the first entity with information in a consortium database to determine a match; and
determine that the first entity is an existing member of the consortium of entities based on at least determining the match.

7. The system of claim 6, wherein the at least one processing device is further configured to:
electronically receive authentication credentials from a computing device associated with the first entity based on at least determining that the first entity is an existing member of the consortium of entities;
verify the first entity based on at least receiving the authentication credentials from the computing device associated with the first entity; and
authorize the first entity to execute the first resource transfer with the second entity based on at least verifying the first entity.

8. A computer implemented method for identifying an entity associated with a genesis resource transfer in a block chain distributed environment by implementing a layered block architecture, the method comprising:
electronically receiving an indication that a first entity has executed a first resource transfer with a second entity, wherein the first resource transfer comprises a transfer of one or more resources associated with the first entity;
generating a first block associated with the first resource transfer for a blockchain distributed ledger, wherein the first block comprises a cryptographic hash for the first resource transfer, and a cryptographic hash for the first entity as a resource transfer entity;
transmitting control signals configured to cause one or more computing devices associated with one or more validating nodes to display the first block associated with the first resource transfer for validation;
electronically receiving, from the one or more computing devices associated with the one or more validating nodes, an indication that the first block has been validated based on one or more logic and rules associated with the blockchain distributed ledger;
determining that a consensus requirement has been met based on at least receiving the indication that the first block has been validated; and
updating the blockchain distributed ledger with the first block based on at least determining that the consensus requirement has been met.

9. The method of claim 8, wherein method further comprises:
electronically receiving an indication that the second entity has executed a second resource transfer with a third entity, wherein the second transfer comprises the transfer of the one or more resources received by the second entity from the first entity via the first resource transfer and one or more resources associated with the second entity that were not received by the second entity from the first entity via the first resource transfer; and
generating a second block associated with the second resource transfer for blockchain distributed ledger, wherein the second block comprises a cryptographic hash for the second resource transfer, the cryptographic hash for the first resource transfer, a cryptographic hash for the second entity as the resource transfer entity, and the cryptographic hash for the first entity as an originating entity.

10. The method of claim 9, wherein the method further comprises:
transmitting control signals configured to cause the one or more computing devices associated with the one or more validating nodes to display the second block associated with the second resource transfer for validation;
electronically receiving, from the one or more computing devices associated with the one or more validating nodes, an indication that the second block has been validated based on the one or more logic and rules associated with the blockchain distributed ledger;
determining that the consensus requirement has been met based on at least receiving the indication that the second block has been validated; and
updating the blockchain distributed ledger with the second block based on at least determining that the consensus requirement has been met, wherein updating further comprises cryptographically linking the second block to the first block.

11. The method of claim 9, wherein the method further comprises:
generating a third block associated with the second resource transfer for the blockchain distributed ledger, wherein the third block comprises a cryptographic hash for the second resource transfer indicating the transfer of the one or more resources received by the second entity from the first entity via the first resource transfer, the cryptographic hash for the second resource transfer, a cryptographic hash for the second entity as the resource transfer entity, and the cryptographic hash for the first entity as the originating entity; and
generating a fourth block associated with the second resource transfer for the blockchain distributed ledger, wherein the fourth block comprises a cryptographic hash for the second resource transfer indicating the transfer of the one or more resources associated with the second entity that were not received by the second entity from the first entity via the first resource transfer, the cryptographic hash for the second resource transfer, the cryptographic hash for the second entity as the resource transfer entity, and a cryptographic hash for the second entity as the originating entity.

12. The method of claim 11, wherein the method further comprises:
transmitting control signals configured to cause the one or more computing devices associated with the one or more validating nodes to display the third block associated with the second resource transfer and the fourth block associated with the second resource transfer for validation;
electronically receiving, from the one or more computing devices associated with the one or more validating nodes, an indication that the third block and the fourth block has been validated based on the one or more logic and rules associated with the blockchain distributed ledger;
determining that the consensus requirement has been met based on at least receiving the indication that the third block and the fourth block has been validated; and
updating the blockchain distributed ledger with the third block and the fourth block based on at least determining that the consensus requirement has been met, wherein updating further comprises cryptographically linking the third block to the second block and cryptographically linking the fourth block to the second block.

13. The method of claim 8, wherein the method further comprises:
electronically receiving an indication that the first entity wishes to execute the first resource transfer with the second entity; and
determining that the first entity is an existing member of a consortium of entities, wherein determining further comprises:
electronically receiving information associated with the first entity;
comparing the information received from the first entity with information in a consortium database to determine a match; and
determine that the first entity is an existing member of the consortium of entities based on at least determining the match.

14. The method of claim 13, wherein the method further comprises:
electronically receiving authentication credentials from a computing device associated with the first entity based on at least determining that the first entity is an existing member of the consortium of entities;
verify the first entity based on at least receiving the authentication credentials from the computing device associated with the first entity; and
authorizing the first entity to execute the first resource transfer with the second entity based on at least verifying the first entity.

15. A computer program product for identifying an entity associated with a genesis resource transfer in a block chain distributed environment by implementing a layered block architecture, the computer program product comprising a non-transitory computer-readable medium comprising code causing a first apparatus to:
electronically receive an indication that a first entity has executed a first resource transfer with a second entity, wherein the first resource transfer comprises a transfer of one or more resources associated with the first entity;
generate a first block associated with the first resource transfer for a blockchain distributed ledger, wherein the first block comprises a cryptographic hash for the first resource transfer, and a cryptographic hash for the first entity as a resource transfer entity;
transmit control signals configured to cause one or more computing devices associated with one or more validating nodes to display the first block associated with the first resource transfer for validation;
electronically receive, from the one or more computing devices associated with the one or more validating nodes, an indication that the first block has been validated based on one or more logic and rules associated with the blockchain distributed ledger;
determine that a consensus requirement has been met based on at least receiving the indication that the first block has been validated; and
update the blockchain distributed ledger with the first block based on at least determining that the consensus requirement has been met.

16. The computer program product of claim 15, wherein the first apparatus is further configured to:
electronically receive an indication that the second entity has executed a second resource transfer with a third entity, wherein the second transfer comprises the transfer of the one or more resources received by the second entity from the first entity via the first resource transfer and one or more resources associated with the second entity that were not received by the second entity from the first entity via the first resource transfer; and
generate a second block associated with the second resource transfer for blockchain distributed ledger, wherein the second block comprises a cryptographic hash for the second resource transfer, the cryptographic hash for the first resource transfer, a cryptographic hash for the second entity as the resource transfer entity, and the cryptographic hash for the first entity as an originating entity.

17. The computer program product of claim 16, wherein the first apparatus is further configured to:
transmit control signals configured to cause the one or more computing devices associated with the one or more validating nodes to display the second block associated with the second resource transfer for validation;
electronically receive, from the one or more computing devices associated with the one or more validating nodes, an indication that the second block has been validated based on the one or more logic and rules associated with the blockchain distributed ledger;
determine that the consensus requirement has been met based on at least receiving the indication that the second block has been validated; and
update the blockchain distributed ledger with the second block based on at least determining that the consensus requirement has been met, wherein updating further comprises cryptographically linking the second block to the first block.

18. The computer program product of claim 16, wherein the first apparatus is further configured to:
generate a third block associated with the second resource transfer for the blockchain distributed ledger, wherein the third block comprises a cryptographic hash for the second resource transfer indicating the transfer of the one or more resources received by the second entity from the first entity via the first resource transfer, the cryptographic hash for the second resource transfer, a cryptographic hash for the second entity as the resource transfer entity, and the cryptographic hash for the first entity as the originating entity; and
generate a fourth block associated with the second resource transfer for the blockchain distributed ledger, wherein the fourth block comprises a cryptographic hash for the second resource transfer indicating the transfer of the one or more resources associated with the second entity that were not received by the second entity from the first entity via the first resource transfer, the cryptographic hash for the second resource transfer, the cryptographic hash for the second entity as the resource transfer entity, and a cryptographic hash for the second entity as the originating entity.

19. The computer program product of claim 18, wherein the first apparatus is further configured to:
transmit control signals configured to cause the one or more computing devices associated with the one or more validating nodes to display the third block associated with the second resource transfer and the fourth block associated with the second resource transfer for validation;
electronically receive, from the one or more computing devices associated with the one or more validating nodes, an indication that the third block and the fourth block has been validated based on the one or more logic and rules associated with the blockchain distributed ledger;
determine that the consensus requirement has been met based on at least receiving the indication that the third block and the fourth block has been validated; and
update the blockchain distributed ledger with the third block and the fourth block based on at least determining that the consensus requirement has been met, wherein updating further comprises cryptographically linking the third block to the second block and cryptographically linking the fourth block to the second block.

20. The computer program product of claim 15, wherein the first apparatus is further configured to:
electronically receive an indication that the first entity wishes to execute the first resource transfer with the second entity; and
determine that the first entity is an existing member of a consortium of entities, wherein determining further comprises:
electronically receiving information associated with the first entity;
comparing the information received from the first entity with information in a consortium database to determine a match; and
determine that the first entity is an existing member of the consortium of entities based on at least determining the match.
